(19) United States
(12) Patent Application Publication
(10) Pub. No.: US 2009/0087731 A1
(43) Pub. Date: Apr. 2, 2009

(54) Lithium secondary battery

(76) Inventors: Atsushi Fukui, Osaka (JP); Maruo Kamino, Osaka (JP)

Correspondence Address: KUBOVCIK & KUBOVCIK, SUITE 1105, 1215 SOUTH CLARK STREET, ARLINGTON, VA, 22202, US

(21) Appl. No.: 12/232,917

(22) Filed: Sep. 25, 2008

(30) Foreign Application Priority Data
Sep. 27, 2007 (JP) 2007-252092
Mar. 27, 2008 (JP) 2008-083896

(51) Int. Cl. H01M 2/02

(52) U.S. Cl. 429/164; 429/163

(57) ABSTRACT

A lithium secondary battery includes: a positive electrode having a positive electrode active material layer disposed on a positive electrode current collector, the positive electrode active material layer containing a positive electrode binder and a positive electrode active material containing a layered lithium-transition metal composite oxide; a negative electrode having a negative electrode current collector and a negative electrode active material layer disposed on the negative electrode current collector, the negative electrode active material layer containing a negative electrode binder and a negative electrode active material containing particles of silicon and/or a silicon alloy; and a non-aqueous electrolyte. Al₂O₃ particles are firmly adhered to a surface of the lithium-transition metal composite oxide so that a BET specific surface area of the positive electrode active material after the adherence of the Al₂O₃ particles is from 1.5 times to 8 times greater than that before the adherence of the Al₂O₃ particles

### BACKGROUND OF THE INVENTION

1. Field of the Invention

The present invention relates to lithium secondary batteries.

2. Description of Related Art

In recent years, lithium secondary batteries have been used as new types of high power, high energy density secondary batteries. The lithium secondary battery uses a non-aqueous electrolyte and performs charge-discharge operations by transferring lithium ions between the positive and negative electrodes.

The lithium secondary batteries, due to their high energy density, have been widely used as the power source for information technology-related portable electronic devices, such as mobile telephones and notebook computers. It has been expected that, due to further size reduction and advanced functions of these portable devices, requirements for the lithium secondary batteries as device power sources will continue to escalate in the future, and thus, demands for higher energy density in lithium secondary batteries have been increasingly high.

An effective means for increasing the energy density of a battery is to use a material that has a large energy density as the active material. In view of this, various proposals and investigations have recently been made into the use of alloy materials of such elements as Al, Sn, and Si in lithium secondary batteries, as negative electrode active materials that can achieve a higher energy density. They are expected to be alternative negative electrode active materials to graphite, which has been in commercial use.

In the electrode that uses a material capable of alloying with lithium as the active material, however, the active material expands and shrinks in volume during the occlusion and release of lithium, causing the active material to pulverize into small particles or peel off from the current collector. This leads to various problems such as degradation in the current collection performance within the electrode and deterioration in charge-discharge cycle performance.

In view of the problem, Japanese Published Unexamined Patent Application No. 2002-260637 discloses a negative electrode that exhibits good charge-discharge cycle performance. This negative electrode is formed by sintering a mixture layer containing a binder and an active material composed of a material containing silicon under a non-oxidizing atmosphere.

According to the above-described conventional technique, the charge-discharge cycle performance is enhanced by improving the adhesion within the negative electrode, i.e., the current collection performance. However, the distribution of the amount of electrolyte solution between the positive electrode and the negative electrode also influences the battery performance greatly. Also from such a point of view, it has been expected to improve the charge-discharge cycle performance of a lithium secondary battery utilizing particles of silicon and/or a silicon alloy as the negative electrode active material.

Japanese Published Unexamined Patent Application Nos. 2002-260637, 2001-143703, 2002-151077, and 2005-276454 disclose coating the surface of lithium cobalt oxide with Al₂O₃ particles, but do not mention the use of Al₂O₃ particles for a lithium secondary battery employing particles of silicon and/or a silicon alloy as the negative electrode active material.

### BRIEF SUMMARY OF THE INVENTION

Accordingly, it is an object of the present invention to provide a lithium secondary battery that achieves improved charge-discharge cycle performance, in a lithium secondary battery that employs particles of silicon and/or a silicon alloy as the negative electrode active material.

In order to accomplish the foregoing and other objects, the present invention provides a lithium secondary battery comprising: a battery case; a non-aqueous electrolyte; and an electrode assembly accommodated in the battery case, the electrode assembly comprising a positive electrode, a negative electrode, and a separator disposed between the positive electrode and the negative electrode, the positive electrode and the negative electrode being disposed facing each other across the separator and being wound; and the negative electrode comprising a negative electrode current collector and a negative electrode active material layer disposed on the negative electrode current collector, the negative electrode active material layer comprising a negative electrode binder and a negative electrode active material containing particles of silicon and/or a silicon alloy; and the positive electrode comprising a positive electrode current collector and a positive electrode active material layer disposed on the positive electrode current collector, the positive electrode active material layer comprising a positive electrode binder and a positive electrode active material containing a layered lithium-transition metal composite oxide, wherein Al₂O₃ particles are firmly adhered to a surface of the lithium-transition metal composite oxide so that a BET specific surface area of the positive electrode active material after the adherence of the Al₂O₃ particles is from 1.5 times to 8 times greater than that before the adherence of the Al₂O₃ particles.

The present invention makes it possible to improve the charge-discharge cycle performance of a lithium secondary battery utilizing particles of silicon and/or a silicon alloy as the negative electrode active material.

### BRIEF DESCRIPTION OF THE DRAWINGS

FIG. 1 is a schematic cross-sectional view illustrating a cylindrical lithium secondary battery according to one embodiment of the present invention;

FIG. 2 is a perspective view illustrating an electrode assembly used for the cylindrical lithium secondary battery according to the embodiment of the present invention;

FIG. 3 is a front view illustrating a prismatic lithium secondary battery according to one embodiment of the present invention;

FIG. 4 is a cross-sectional view taken along line A-A in FIG. 3;

FIG. 5 is a perspective view illustrating an electrode assembly used for the prismatic lithium secondary battery according to the embodiment of the present invention; and

FIG. 6 is an XRD chart for Al₂O₃—Li₃PO₄ particles, prepared according to one embodiment of the present invention.

### DETAILED DESCRIPTION OF THE INVENTION

A lithium secondary battery according to the present invention comprises: a battery case; a non-aqueous electrolyte; and an electrode assembly accommodated in the battery case, the electrode assembly comprising a positive electrode, a negative electrode, and a separator disposed between the positive electrode and the negative electrode, the positive electrode and the negative electrode being disposed facing each other across the separator and being wound. The negative electrode comprises a negative electrode current collector and a negative electrode active material layer disposed on the negative electrode current collector, the negative electrode active material layer comprising a negative electrode binder and a negative electrode active material containing particles of silicon and/or a silicon alloy. The positive electrode comprises a positive electrode current collector and a positive electrode active material layer disposed on the positive electrode current collector, the positive electrode active material layer comprising a positive electrode binder and a positive electrode active material containing a layered lithium-transition metal composite oxide. Al₂O₃ particles are firmly adhered to a surface of the lithium-transition metal composite oxide so that a BET specific surface area of the positive electrode active material after the adherence of the Al₂O₃ particles is from 1.5 times to 8 times greater than that before the adherence of the Al₂O₃ particles.

In the case that particles of silicon and/or a silicon alloy are used as the negative electrode active material, the particles undergo volumetric changes as the charge-discharge cycle proceeds, and fractures develop in each of the particles. The fractures appear particularly greatly in the surface of the active material particle, so the surface area of the active material particle increases significantly. As the surface area increases, the amount of the electrolyte solution that can exist in the surface of the negative electrode active material particle increases, and the electrolyte solution absorbency of the negative electrode increases. However, the amount of the electrolyte solution within a battery is limited. Therefore, if the solution absorbency of the negative electrode increases, the release of the electrolyte solution from the positive electrode is promoted, and the distribution of the amount of the electrolyte solution becomes different from that at the initial stage of battery cycles.

The decrease of the amount of the electrolyte solution in the positive electrode increases the electrochemical polarization and non-uniform reactions in the positive electrode, causing oxidative decomposition of the electrolyte solution on the positive electrode active material surface and breakdown of crystal structure of the positive electrode active material. As a consequence, the battery performance is considerably deteriorated.

In the present invention, Al₂O₃ particles are firmly adhered onto the surface of the lithium-transition metal composite oxide so that the lithium-transition metal composite oxide after the Al₂O₃ particles are firmly adhered has a BET specific surface area from 1.5 times to 8 times greater than that before the Al₂O₃ particles are firmly adhered. As a result, the surface area of the positive electrode is increased, and the electrolyte solution absorbency, i.e., the electrolyte retention capability of the positive electrode can be improved. Thus, even when the electrolyte solution absorbency of the negative electrode increases as the charge-discharge cycle proceeds, drying out of the electrolyte solution does not occur easily in the positive electrode since the electrolyte solution absorbency, i.e., the electrolyte retention capability of the positive electrode is kept high. As a result, the charge-discharge cycle performance is improved.

Moreover, because the Al₂O₃ particles exist on the surface of the lithium-transition metal composite oxide, the portion of the positive electrode active material that directly comes into contact with the electrolyte solution is kept small, so oxidative decomposition of the electrolyte solution in the positive electrode occurs less easily. Also from this point of view, the charge-discharge cycle performance is improved.

In the present invention, it is more preferable that the BET specific surface area of the lithium-transition metal composite oxide after the Al₂O₃ particles are firmly adhered be within the range of from 2.5 times to 7.5 times that before the Al₂O₃ particles are firmly adhered.

If the BET specific surface area of the lithium-transition metal composite oxide after the Al₂O₃ particles are firmly adhered is less than 1.5 times that before the Al₂O₃ particles are firmly adhered, the electrolyte solution absorbency, i.e., the electrolyte retention capability of the positive electrode may not be sufficiently improved. On the other hand, if the BET specific surface area of the lithium-transition metal composite oxide after the Al₂O₃ particles are firmly adhered exceeds 8 times that before the Al₂O₃ particles are firmly adhered, the electron conductivity between positive electrode active material particles may lower, and the charge-discharge characteristics may degrade, since the amount of the Al₂O₃ particles that are firmly adhered to the lithium-transition metal composite oxide is too great.

The BET specific surface area of the lithium-transition metal composite oxide after the Al₂O₃ particles are firmly adhered should preferably be within the range of from 0.4 m²/g to 2.5 m²/g, and more preferably be within the range of from 1.0 m²/g to 2.0 m²/g. The BET specific surface area of the lithium-transition metal composite oxide before the Al₂O₃ particles are firmly adhered, in other words, the BET specific surface area of the base lithium-transition metal composite oxide should preferably be within the range of from 0.15 m²/g to 1.0 m²/g. In the present invention, it is preferable that the positive electrode active material layer have a porosity of from 15% to 28%. By controlling the porosity within this range, it is possible to obtain high energy density and good cycle performance. If the porosity of the positive electrode active material layer exceeds 28%, the energy density of the positive electrode becomes poor although the electrolyte retention capability of the positive electrode improves. Consequently, a high energy density battery may not be obtained. Moreover, since the contact area between the particles of the positive electrode active material decreases, the current collection performance may degrade, resulting in poor charge-discharge characteristics.

On the other hand, if the porosity of the positive electrode active material layer is less than 15%, a high energy density is achieved. However, the amount of electrolyte solution that can be retained within the positive electrode active material layer decreases, and the distribution of the amounts of electrolyte solution between the positive electrode and the negative electrode tends to change easily. As a consequence, good charge-discharge cycle performance may not be obtained.

In the present invention, it is preferable that the above-described range of the BET specific surface area be obtained by firmly adhering Li₃PO₄ particles in addition to the Al₂O₃ particles. The presence of the Li₃PO₄ particles on the positive electrode active material surface hinders the positive electrode active material from deteriorating. Li₃PO₄ has the effect of hindering breakdown of crystal structure of the lithium-transition metal composite oxide. In lithium secondary batteries, LiPF₆ is commonly used as the electrolyte of the non-aqueous electrolyte solution. LiPF₆ reacts with a trace amount of water existing in the battery and produces HF. The resulting HF is known to cause breakdown of crystal structure of the lithium-transition metal composite oxide. Nevertheless, when Li₃PO₄ is present on the positive electrode active material surface, the HF reacts predominantly with the Li₃PO₄. Thus, the HF can be captured, and the breakdown of crystal structure of the lithium-transition metal composite oxide due to the HF can be hindered.

Furthermore, high lithium ion conductivity can be obtained when Li₃PO₄ and Al₂O₃ coexist. For this reason, even though the direct contact area between the electrolyte solution and the positive electrode active material surface decreases because of the coexistence of the Li₃PO₄ and Al₂O₃ on the positive electrode active material surface, the lithium ion conductivity of the positive electrode active material is maintained, and therefore, excellent charge-discharge characteristics can be obtained.

The lithium secondary battery of the present invention has a configuration in which an electrode assembly formed by opposing the positive electrode and the negative electrode across a separator and winding them is accommodated in a battery case. Although not particularly limited, it is preferable that the electrode assembly be a spirally-wound cylindrical electrode assembly, and the battery case is in a cylindrical shape. In other words, it is preferable that the lithium secondary battery of the present invention be a cylindrical battery.

In a cylindrical battery, deformation of the electrode assembly does not easily occur because of the mechanical strengths of the wound electrode assembly containing the positive electrode, the negative electrode, and the separator. This means that, when the particles of silicon and/or a silicon alloy, the volume of which expands during occlusion of lithium, are used as the negative electrode active material as in the present invention, the stress resulting from the volumetric expansion of the active material acts entirely on the positive electrode, the negative electrode, and the separator in the electrode assembly. Accordingly, during charge, in which the active material expands, the positive electrode active material layer is compressed, so the non-aqueous electrolyte tends to be squeezed out easily from the positive electrode active material layer and the electrolyte retention capability of the positive electrode tends to be lowered. In the present invention, the-electrolyte retention capability of the positive-electrode is improved by firmly adhering Al₂O₃ to the positive electrode active material surface. Therefore, the advantageous effects of the present invention are more easily obtained in cylindrical batteries.

In the present invention, it is preferable that the amount of the Al₂O₃ particles firmly adhered to the surface of the lithium-transition metal composite oxide be within the range of from 0.1 weight % to 1.5 weight % with respect to the amount of the lithium-transition metal composite oxide, more preferably from 0.3 weight % to 1 weight %. Accordingly, it is preferable that 0.1 to 1.5 parts by weight, more preferably 0.3 to 1 parts by weight, of Al₂O₃ be firmly adhered to 100 parts by weight of the lithium-transition metal composite oxide. By controlling the amount of Al₂O₃ within the above-described ranges, the electrolyte retention capability of the positive electrode can be further heightened, and higher energy density and better charge-discharge cycle performance can be obtained.

In the present invention, it is preferable that the amount of Li₃PO₄ particles firmly adhered to the surface of the lithium-transition metal composite oxide be within the range of from 0.4 weight % to 1.2 weight % of the amount of the lithium transition metal composite oxide. In other words, it is preferable that the amount of the Li₃PO₄ particles be within the range of from 0.4 to 1.2 parts by weight with respect to 100 parts by weight of the amount of the lithium-transition metal composite oxide. If the amount of the Li₃PO₄ particles is less than 0.4 weight %, the effect of hindering the deterioration of the positive electrode active material may not be obtained sufficiently since the amount of the LI₃PO₄ particles is too small. On the other hand, if the amount exceeds 1.2 weight %, the electron conductivity between the positive electrode active material particles may degrade and the charge-discharge characteristics may become poor since the amount of the Li₃PO₄ particles is too large.

In the present invention, the method for firmly adhering Al₂O₃ particles to the surface of the lithium-transition metal composite oxide is not particularly limited. An example of the method is as follows. An alkaline solution is dropped into an aqueous solution containing an aluminum salt to deposit Al(OH)₃ particles. A lithium-transition metal composite oxide is added thereto so that the Al(OH)₃ particles are adhered onto the surface thereof. Thereafter, the lithium-transition metal composite oxide with the Al(OH)₃ particles is sintered. A preferable range of the sintering temperature is from 400 C. to 600 C., for example.

Specifically, for example, aluminum nitrate may be used as the aqueous solution of an aluminum salt, and an ammonia aqueous solution may be used as the alkaline aqueous solution. In this method, the NH₃ aqueous solution is dropped into the Al(NO₃)₃ aqueous solution to deposit Al(OH)₃ particles. Next, water is added to the solution to prepare a dispersion of Al(OH)₃ particles, and a lithium-transition metal composite oxide is added thereto, so that Al(OH)₃ particles are adhered onto the surface of the lithium-transition metal composite oxide. Then, the resultant material is sintered at 400° C. or higher to change the Al(OH)₃ particles into Al₂O₃ particles, whereby Al₂O₃ particles are firmly adhered to the surface of the lithium-transition metal composite oxide.

It is also possible to employ a method in which a lithium-transition metal composite oxide is added to an Al(NO₃)₃ aqueous solution in advance and thereafter a NH₃ aqueous solution is dropped thereto. In this case, however, the Al(NO₃)₃ aqueous solution, which is acidic, may deteriorate the lithium-transition metal composite oxide, and the charge-discharge characteristics may consequently deteriorate.

The Al₂O₃ that is firmly adhered to the surface of the lithium-transition metal composite oxide may preferably be, but is not particularly limited to, γ-Al₂O₃.

The method for firmly adhering the Li₃PO₄ particles to the surface of the lithium-transition metal composite oxide in addition to the Al₂O₃ particles is not particularly limited. An example is as follows.

First, a NH₃ aqueous solution is added to a (NH₄)₂HPO₄ aqueous solution so that the pH is adjusted to be 7 or higher, and a lithium transition metal oxide is added to the solution. Also, a Al(NO₃)₃ aqueous solution is gradually dropped to the resultant solution to cause AlPO₄ particles to firmly adhere to the lithium transition metal oxide surface. Next, a LiOH aqueous solution is added thereto, to change the AlPO₄ particles into Al(OH)₃—Li₃PO₄ particles. Lastly, the resultant material is sintered at 400° C. or higher to change the Al(OH)₃—Li₃PO₄ particles into Al₂O₃—Li₃PO₄ particles, whereby a material in which Al₂O₃—Li₃PO₄ particles are firmly adhered to the surface of the lithium-transition metal composite oxide can be obtained. In this method, it is important to adjust the pH to be 7 or higher by adding the NH₃ aqueous solution to the(NH₄)₂HPO₄ aqueous solution. When the aqueous solution is kept to be alkaline during the treatment, deterioration of the lithium-transition metal composite oxide, which occurs when the aqueous solution becomes acidic, is prevented. Moreover, the size of the Al₂O₃—Li₃PO₄ particles that firmly adhere to the lithium-transition metal composite oxide surface becomes smaller, and it becomes possible to achieve highly uniform surface adherence.

The electrolyte retention capability of the positive electrode can be improved by reducing the viscosity of the non-aqueous electrolyte, as well as increasing the surface area of the positive electrode active material by firmly attaching Al₂O₃ particles to the surface. This is because the permeability of the non-aqueous electrolyte in the positive electrode increases when the viscosity is reduced. Moreover, increasing the electrolyte retention capability of the positive electrode serves to prevent a change in the distribution of the non-aqueous electrolyte between the positive electrode and the negative electrode, hindering the particles of silicon or a silicon alloy from deteriorating, even when the particles of silicon or a silicon alloy start to deteriorate as the charge-discharge cycles proceed and a slight change of the balance of the electrolyte solution absorbency between the positive electrode and the negative electrode starts to occur.

In the present invention, it is preferable to use a carbonate-based solvent as a solvent of the non-aqueous electrolyte, in order to promote the occlusion and release of lithium at the surfaces of the positive electrode active material and the negative electrode active material. An example of the carbonate-based solvent that has a particularly low viscosity is dimethyl carbonate. Thus, the use of dimethyl carbonate makes it possible to reduce the viscosity of the non-aqueous electrolyte and increase the electrolyte retention capability of the positive electrode. However, a problem with the use of dimethyl carbonate is that it is prone to oxidative decomposition when the electrode potential becomes high.

In the present invention, particles of silicon and/or a silicon alloy are used as the negative electrode active material. This type of negative electrode tends to show a higher potential during charge and discharge than the graphite negative electrode. The charge-discharge potential becomes particularly higher under the charge-discharge condition in which the theoretical electrical capacity ratio of the negative electrode to the positive electrode is set to be 1 or greater to make the depth of occlusion and release of lithium in the negative electrode shallow for the purpose of hindering the deterioration of the negative electrode active material due to the charge-discharge cycling. Accordingly, even when charge and discharge are performed in the same battery voltage range, the positive electrode potential becomes higher as the negative electrode potential becomes higher, so the positive electrode potential is higher in the present invention than in case of the graphite negative electrode battery. Therefore, when dimethyl carbonate is contained in the non-aqueous electrolyte, oxidative decomposition of the dimethyl carbonate tends to occur very easily at the positive electrode active material surface.

However, by firmly adhering Al₂O₃ particles to the surface of the positive electrode active material according to the present invention, the proportion of the dimethyl carbonate that directly comes into contact with the positive electrode active material can be reduced, and accordingly, the oxidative decomposition of the dimethyl carbonate can be minimized. Thus, according to the present invention, the oxidative decomposition of dimethyl carbonate can be hindered, and as a result, dimethyl carbonate can be used as a solvent of the non-aqueous electrolyte so that the viscosity of the non-aqueous electrolyte can be reduced. As a result, the non-aqueous electrolyte can be retained in the positive electrode more desirably, and excellent charge-discharge characteristics can be obtained.

In addition, dimethyl carbonate tends to easily undergo reductive decomposition on the surface of the silicon negative electrode active material. The reaction product originating from this reductive decomposition moves to the positive electrode. The reaction product is decomposed and deposited on the positive electrode surface, so it increases the charge-discharge reaction resistance at the interface between the electrode and the non-aqueous electrolyte and lowers the charge-discharge characteristics. However, by firmly adhering Al₂O₃ particles to the surface of the positive electrode active material according to the present invention, the proportion of the dimethyl carbonate that directly comes into contact with the positive electrode active material can be reduced. As a result, it becomes possible to prevent the reductive decomposition product from being further decomposed on the positive electrode surface. Also from this viewpoint, the present invention can resolve the problem associated with the use of dimethyl carbonate and achieve improved charge-discharge characteristics because of the reduction in the viscosity of the non-aqueous electrolyte by using dimethyl carbonate.

In the present invention, it is preferable that the content of dimethyl carbonate be from 10 volume % to 90 volume % in the solvent. If the content of dimethyl carbonate is less than 10 volume %, the effect of reducing the viscosity of the non-aqueous electrolyte cannot be obtained sufficiently, so the effect of improving the charge-discharge characteristics resulting from the dimethyl carbonate may not be obtained sufficiently. On the other hand, if the content of dimethyl carbonate exceeds 90 volume %, the reductive decomposition excessively takes place on the surface of the silicon negative electrode active material. As a consequence, lithium ion conductivity may become poor because of the consequent change in the electrolyte solution composition, and the charge-discharge characteristics may degrade.

Hereinbelow, a negative electrode, a positive electrode, a non-aqueous electrolyte, and a binder in the lithium secondary battery according to the present invention will be described in detail.

### Negative Electrode Active Material

The negative electrode in the present invention comprises particles containing silicon and/or a silicon alloy. Examples of the silicon alloy include solid solutions of silicon and at least one other element, intermetallic compounds of silicon and at least one other element, and eutectic alloys of silicon and at least one other element.

As the negative electrode active material particles in the present invention, it is possible to use particles obtained by coating the surface of each particle containing silicon and/or a silicon alloy with a metal or the like. Examples of the method of the coating include electroless plating, electroplating, chemical reduction, evaporation, sputtering, and chemical vapor deposition.

In the present invention, particles made of silicon alone may also be used preferably as the negative electrode active material.

In the lithium secondary battery of the present invention, it is preferable that the average particle size of the negative electrode active material particles be from 7 μm to 17 μm. If the average particle size of the negative electrode active material particles is less than 7 μm, the increase of the surface area will be large when the fractures of the silicon develop as the charge-discharge cycle progresses because the surface area of the original silicon active material before the charge-discharge cycle is large. Therefore, the increase of the electrolyte solution absorbency of the negative electrode tends to be large, and the distribution of the amounts of electrolyte solution between the positive electrode and the negative electrode tends to change easily. Thus, the charge-discharge cycle performance tends to be poor. If the average particle size of the negative electrode active material particles exceeds 17 μm, the absolute magnitude of the volumetric expansion at the time of occlusion of lithium is great per each one of the negative electrode active material particles, so the stress resulting from the volumetric change accordingly becomes great. Accordingly, the compression of the positive electrode active material layer in the wound electrode assembly is greater, and the amount of the electrolyte solution released from the positive electrode is greater. As a consequence, the distribution of the amounts of electrolyte solution between the positive electrode and the negative electrode tends to change easily, and the charge-discharge cycle performance degrades.

In addition to the foregoing, the following reasons should be mentioned. If the average particle size of the negative electrode active material particles is less than 7 μm, the increase of the surface area will be large when the fractures of the silicon develop as the charge-discharge cycle progresses because the surface area of the original silicon active material before the charge-discharge cycle is large. The portion in which the fractures have occurred is a newly exposed surface that is active, where the decomposition reaction of the electrolyte solution and the associated degradation of the silicon active material tend to take place easily. The greater the surface area of the active material is, the greater the proportion of the area in which the fractures occur, and the battery performance significantly degrades. If the average particle size of the negative electrode active material particles exceeds 17 μm, the absolute magnitude of the volumetric expansion at the time of occlusion of lithium is great per each one of the negative electrode active material particles, and the deformation of the negative electrode binder, which serves to keep the adherence in the negative electrode active material layer, also becomes great. Consequently, destruction of the negative electrode binder tends to occur easily, leading to degradation of the current collection performance, and the charge-discharge characteristics accordingly degrades.

It is preferable that the particle size distribution of the negative electrode active material particles in the lithium secondary battery of the invention be as narrow as possible. A wide particle size distribution means that there are large differences in the absolute amounts of the volumetric expansion and shrinkage, associated with the occlusion and release of lithium, between active material particles with greatly varying particle sizes. Therefore, a strain occurs in the mixture layer, and consequently, destruction of the binder occurs. Consequently, current collection performance in the electrode lowers, degrading the charge-discharge characteristics.

It is preferable that the particles of silicon and/or a silicon alloy, serving as the negative electrode active material in the present invention, have a crystallite size of 100 nm or less. In the silicon/silicon alloy particles of the present invention that have a crystallite size of 100 nm or less, a large number of crystallites exist in a particle because the crystallite size is small relative to the particle size. Since the orientations of the crystallites are disordered, the silicon/silicon alloy particles of the present invention are less prone to fractures than single crystals.

Furthermore, since the crystallite size is small, 100 nm or less, there exist a large number of grain boundaries in a particle due to the smallness of the crystallite size relative to the size of the active material particles. This means that lithium can be transferred into the active material particles more easily by grain boundary diffusion of lithium during charge and discharge, so the reaction in the particle is highly uniform. Thereby, it is possible to avoid the fractures of the particles resulting from a large strain due to an increase of the amounts of volumetric changes in the particle, unlike the case that the reaction uniformity in the particle is low. As a result, the fractures of the particles can be minimized.

When the fractures of the active material particles are minimized in this way, newly exposed surfaces, which are highly reactive with the non-aqueous electrolyte solution, do not increase during the charge-discharge reactions, and accordingly it is also possible to minimize the expansion of the active material particles associated with degradation at the newly exposed surfaces, which is caused by the side reaction with the non-aqueous electrolyte solution. As a result, excellent charge-discharge cycle performance can be obtained.

The silicon particles and/or silicon alloy particles with a crystallite size of 100 nm or less may be prepared by thermal decomposition or thermal reduction. Herein, the term “thermal decomposition” refers to a method of depositing silicon by thermally decomposing a material containing a silane compound such as trichlorosilane (SiHCl₃), monosilane (SiH₄), and disilane (Si₂H₆). The term “thermal reduction” refers to a method of depositing silicon by thermally decomposing a material containing a silane compound such as trichlorosilane (SiHCl₃), monosilane (SiH₄), and disilane (Si₂H₆), under a reducing atmosphere.

In order to produce silicon particles with a smaller crystallite size, it is preferable that the temperature at which the silane compound is thermally decomposed be as low as possible. The lower the temperature of the thermal decomposition is, the more likely the particles with a smaller crystallite size can be produced. Here, when trichlorosilane (SiHCl₃) is used as the source material in the thermal decomposition or the thermal reduction, the minimum temperature necessary for the thermal decomposition at which the silicon is deposited appropriately is about 900° C. to 1000° C. When monosilane (SiH₄) is used, the minimum temperature is about 600° C. to 800° C., so the deposition of the silicon is possible at a lower temperature. For this reason, it is preferable to use monosilane (SiH₄) as the source material when preparing silicon particles with a small crystallite size, which are suitable for the present invention.

It is preferable that the silicon particles and silicon alloy particles of the present invention be produced by pulverizing and classifying a silicon ingot prepared by thermal decomposition or thermal reduction. When grain boundaries exist in a silicon ingot, mechanical pulverization of the ingot results in fractures along the grain boundaries. The silicon ingot prepared by thermal decomposition or thermal reduction, which has a small crystallite size, has a large number of grain boundaries. Therefore, if the silicon ingot is pulverized to an average particle size of 7 μm to 17 μm, which is preferable for the present invention, a large number of grain boundary surfaces appear at the particles' surface. As a consequence, the particle surface becomes extremely irregular. When the surfaces of the negative electrode active material particles have such irregularities, the negative electrode binder goes into the irregular portions, exerting an anchoring effect. As a result, adhesion capability of the negative electrode active material particles with one another improves further. In the case that the negative electrode binder is thermoplastic, the negative electrode binder can go into the irregularities in the surfaces of the silicon/silicon alloy particles more (i.e., the heat bonding effect of the negative electrode binder can become more significant) by carrying out the heat treatment in the electrode preparation at a temperature above the thermoplastic temperature range of the negative electrode binder. As a result, the adhesion capability improves still further. When the adhesion capability in the negative electrode is higher, the current collection performance can be kept higher even if the negative electrode active material undergoes volumetric changes due to charge and discharge. Accordingly, the uniformity of the reactions in the negative electrode improves, and the development of the expansion of the negative electrode active material due to its deterioration is suppressed. As a result, excellent charge-discharge cycle performance can be obtained.

It is preferable that the silicon particles, which serve as the negative electrode active material in the present invention, contain oxygen and, as an impurity, at least one element selected from the group consisting of phosphorus, boron, aluminum, iron, calcium, sodium, gallium, lithium, and indium.

When at least one of the just-mentioned impurities is contained in the silicon particles, the electron conductivity of the silicon particles is improved. Therefore, the current collection performance within the negative electrode mixture layer improves, and the uniformity of the electrode reaction also improves. It should be noted that oxygen is included in addition to the impurities such as phosphorus because oxygen is unavoidably present because of the surface oxidation of silicon.

Among the above-listed impurities, phosphorus and boron are particularly preferable. Phosphorus and boron can each be contained in silicon in the form of a solid solution up to an amount of about several hundred ppm. In this case, the electron conductivity within the particle becomes especially high. Such silicon in which phosphorus or boron is contained in the form of a solid solution may be formed preferably by adding a phosphorus source or a boron source, such as phosphine (PH₃) or diborane (B₂H₆), in an appropriate amount, to a silane compound that is a source material of the thermal decomposition or the thermal reduction.

### Negative Electrode Binder

In the present invention, it is preferable that the negative electrode binder have a high mechanical strength and good elasticity. Even in the case that the volume of the silicon negative electrode active material changes during occlusion and release of lithium, the excellent mechanical properties of the binder allows the negative electrode mixture layer to change its shape according to the volumetric change of the silicon active material without causing destruction of the binder. As a result, the current collection performance in the electrode can be maintained, and excellent charge-discharge cycle performance can be obtained. Moreover, because of the high mechanical strength, the silicon particles are placed under stress such as to be pressed toward the negative electrode current collector side even when the silicon particles undergo volumetric expansion during charge. This stress prevents the expansion resulting from deterioration of the silicon from developing as the cycle progresses. The silicon active material has the nature that the development of the expansion tends to be hindered when external force is applied thereto during charge and discharge. A preferable example of the binder that has high mechanical properties is a polyimide resin. Fluoropolymers such as polyvinylidene fluoride and polytetrafluoroethylene may also be suitably used.

It is particularly preferable that the negative electrode binder be thermoplastic. For example, in the case that the negative electrode binder has a glass transition temperature or melting point, the binder is thermally bonded to the negative electrode active material particles and the negative electrode current collector by performing a heat treatment for sintering the negative electrode mixture layer onto the surface of the negative electrode current collector at a higher temperature than the glass transition temperature or melting point of the binder. As a result, the tightness of the bond between the active material particles and between the mixture layer and the current collector further improves. Thus, it is possible to improve the current collection performance in the electrode greatly and to obtain even better charge-discharge performance. When performing the heat treatment for heat bonding, it is preferable that the heat treatment be conducted at a temperature lower than the thermal decomposition temperature of the binder. If the heat treatment is conducted at a temperature higher than the thermal decomposition temperature of the binder, the function of the binder cannot be obtained fully because the binder undergoes decomposition and the mechanical properties degrade. As a consequence, the current collection performance in the negative electrode lowers, and the charge-discharge characteristics deteriorate accordingly.

In the present invention, it is preferable that the amount of the negative electrode binder be 5 weight % or greater of the total weight of the negative electrode mixture layer, and the volume occupied by the binder be 5% or greater of the total volume of the negative electrode active material layer. It should be noted here that the total volume of the negative electrode active material layer means the total of the volumes of the materials contained in the active material layer, such as active material and binder, and that it does not include the volume of voids in the active material layer if such voids exist in the active material layer.

### Negative Electrode Current Collector

A preferable example of the negative electrode current collector is a conductive metal foil. It is preferable that the negative electrode current collector have a surface roughness Ra of from 0.2 μm to 10 μm in the surface on which the negative electrode mixture layer is disposed. The use of the conductive metal foil with such a surface roughness Ra as the negative electrode current collector allows the negative electrode binder to get into the portions of the current collector surface in which surface irregularities exist, exerting an anchoring effect and thereby providing strong adhesion between the binder and the current collector. As a result, it is possible to prevent the active material layer from peeling off from the current collector even when the silicon active material particles undergo volumetric changes associated with the occlusion and release of lithium. In the case that the negative electrode active material layer is disposed on both sides of the negative electrode current collector, it is preferable that both sides of the negative electrode current collector have a surface roughness Ra of 0.2 μm or greater.

It is preferable that the just-mentioned surface roughness Ra and mean spacing of local peaks S have a relationship 100Ra≦S. Surface roughness Ra and mean spacing of local peaks S are defined in Japanese Industrial Standards (JIS B 0601-1994) and can be measured by, for example, a surface roughness meter.

To provide the current collector with a surface roughness Ra of 0.2 μm or greater, it is preferable that the conductive metal foil be subjected to a roughening process. Examples of the roughening process include plating, vapor deposition, etching, and polishing.

In the present invention, when a heat treatment for the negative electrode is performed to improve the adhesion capability due to thermal bonding of the negative electrode binder as described above, it is preferable that the negative electrode current collector be less prone to be softened by the heat treatment, i.e., the negative electrode current collector have high heat resistance. If the negative electrode current collector is softened and the mechanical strength is reduced, deformation of the current collector occurs as the silicon active material changes in volume during charge and discharge, and charge-discharge cycle performance deteriorates.

Examples of the conductive metal foil that has a high mechanical strength and a high heat resistance include alloy foils. Particularly preferable is an alloy foil comprising an element including copper, nickel, iron, titanium, cobalt, manganese, and tin, or combinations thereof.

### Negative Electrode Conductive Agent

In the negative electrode of the present invention, conductive powder may be mixed as a conductive agent in the active material layer. By adding conductive powder, a conductive network of the conductive powder forms around the active material particles, making it possible to further improve the current collection performance in the electrode. For the conductive powder, the same kinds of materials as those for the above-described conductive metal foil may be suitably used. Specific examples include metals such as copper, nickel, iron, titanium, cobalt, and manganese as well as alloys and mixtures thereof. In particular, copper powder is preferable as the metal powder. Conductive-carbon powder may also be preferably used.

It is preferable that the average particle size of the conductive powder be from 1 μm to 10 μm.

### Preparation of Negative Electrode

In the present invention, it is preferable that the negative electrode be prepared by uniformly mixing and dispersing the negative electrode active material particles in a solution of the negative electrode binder to produce a slurry, and applying the resultant slurry onto a surface of the negative electrode current collector to form a negative electrode mixture layer. In this way, the negative electrode binder is allowed to be uniformly present in the negative electrode active material layer, so that the binding effect by the negative electrode binder is effectively obtained. As a result, strong adhesion is obtained in the negative electrode.

In addition, when a thermoplastic material is used as the negative electrode binder, the negative electrode of the present invention should preferably be prepared by performing a heat treatment in a temperature range of from the glass transition temperature or the melting point of the negative electrode binder to the thermal decomposition temperature of the negative electrode binder, in a state that the negative electrode mixture layer is formed on the negative electrode current collector, in order to effect thermal bonding of the binder for improving the binding performance further. When a foil containing elemental copper is used as the negative electrode current collector, the heat treatment should be performed at 200° C. or higher. Thereby, the elemental copper in the negative electrode current collector is diffused into the silicon negative electrode active material in the negative electrode active material layer. Thus, the sintering effect is obtained, and further strong adhesion can be obtained. It is preferable that the heat treatment be carried out under an inert gas atmosphere, such as vacuum, a nitrogen atmosphere, or an argon atmosphere, or under a reducing atmosphere, such as a hydrogen atmosphere.

### Positive Electrode Active Material

In the present invention, a preferable example of the positive electrode active material is a layered lithium-transition metal composite oxide represented by the chemical formula LiₐNiₓMn_{y}CO_{z}O₂ (wherein 0≦a≦1.1, x+y+z=1, 0≦x≦1, 0≦y≦1, and 0≦z≦1). Examples of the layered lithium-transition metal composite oxide include LiCoO₂, LiNiO₂, LiMn₂O₄, LiMnO₂, LiNi_{0.5}Co_{0.5}O₂, LiNi_{0.7}Co_{0.3}O₂, LiNi_{0.8}Co_{0.2}O₂, and LiNi_{0.33}Co_{0.33}Mn_{0.34}O₂. Particularly preferable are LiNi_{0.8}CO_{0.2}O₂ and LiCoO₂. In addition, the lithium-transition metal composite oxide may contain at least one element selected from the group consisting of titanium, magnesium, zirconium, and aluminum.

It is preferable that the average particle size of the lithium-transition metal composite oxide (the average particle size of its secondary particles) be 20μm or less. If the average particle size exceeds 20 μm, the distance of diffusion of the lithium ions within a particle of the lithium-transition metal composite oxide will be too large, resulting in poor charge-discharge cycle performance.

Various known conductive agents may be used for the positive electrode conductive agent. Preferable examples include a conductive carbon material. Acetylene black and Ketjen Black are particularly preferable.

Various known binders may be used as the positive electrode binder without limitation as long as the binders do not dissolve in the solvent used for the non-aqueous electrolyte in the present invention. Preferable examples include fluororesins such as polyvinylidene fluoride, polyimide-based resins, and polyacrylonitriles.

A preferable example of the positive electrode current collector is a conductive metal foil. Any conductive metal foil may be used as the positive electrode current collector as long as it does not dissolve in the non-aqueous electrolyte and is stable at the potential applied to the positive electrode during charge and discharge. Particularly preferable is an aluminum foil.

### Non-Aqueous Electrolyte

Examples of the solvent of the non-aqueous electrolyte that are usable in the lithium secondary battery of the present invention include, but are not particularly limited to, cyclic carbonates such as ethylene carbonate, propylene carbonate, butylene carbonate, and vinylene carbonate; chain carbonates such as dimethyl carbonate, ethyl methyl carbonate, and diethyl carbonate; esters such as methyl acetate, ethyl acetate, propyl acetate, methyl propionate, ethyl propionate, and γ-butyrolactone; ethers such as 1,2-dimethoxyethane, 1,2-diethoxyethane, tetrahydrofuran, 1,2-dioxane, and 2-methyltetrahydrofuran; nitrites such as acetonitrile; and amides such as dimethylformamide. These solvents may be used either alone or in combination. Particularly preferred is a mixed solvent of a cyclic carbonate and a chain carbonate.

As described above, the present invention resolves the problems with the use of dimethyl carbonate, and makes it possible to use dimethyl carbonate as a solvent without causing such problems. As a result, the viscosity of the non-aqueous electrolyte can be reduced, and the charge-discharge characteristics can be improved further.

In the present invention, examples of the solute of the non-aqueous electrolyte include, but are not particularly limited to: lithium compounds represented by the chemical formula LiₓF_{y} (wherein x is P, As, Sb, B, Bi, Al, Ga, or In; and y is 6 when x is P, As, or Sb; or y is 4 when x is B, Bi, Al, Ga, or In), such as LiPF₆, LiBF₄, and LiAsF₆; as well as lithium compounds such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiClO₄, Li₂B₁₀Cl₁₀, and Li₂B₁₂Cl₁₂. Of these substances, LiPF₆ is particularly preferred.

Examples of the non-aqueous electrolyte in the present invention include gelled polymer electrolytes in which the electrolyte solution is impregnated in a polymer electrolyte such as polyethylene oxide or polyacrylonitrile, and inorganic solid electrolytes such as LiI and Li₃N.

In the present invention, it is desirable that the non-aqueous electrolyte contain CO₂ and/or fluoroethylene carbonate. CO₂ and carbonic acid esters containing F element (such as fluoroethylene carbonate) have the effect of allowing the reaction between the silicon active material and lithium on the active material surface to occur smoothly during charge and discharge. This improves reaction uniformity and serves to lessen the expansion of the silicon active material. As a result, excellent cycle performance can be obtained.

The non-aqueous electrolyte of the invention can be used without restriction as long as the lithium compound, which functions as a solute that achieves lithium ion conductivity, and the solvent, which dissolves and retains the solute, are not decomposed during charge/discharge or storage of the battery.

### Separator

In the present invention, it is preferable that the separator be a microporous polyolefin film such as that made of polyethylene or polypropylene. It is particularly preferable that the separator be a microporous polyolefin film having a penetration resistance of 350 g or greater and a porosity of 40% or greater. By controlling the penetration resistance of the separator to be 350 g or greater and the porosity to be 40% or greater, the separator is less likely to suffer from the clogging of the separator resulting from the compression of the separator due to the expansion of the silicon active material even when the expansion develops as the charge-discharge cycle progresses, preventing the lithium ion conductivity between the positive and negative electrodes from degrading. Thus, excellent cycle performance can be obtained.

Hereinbelow, the present invention is described in further detail. It should be construed, however, that the present invention is not limited to the following preferred embodiments but various changes and modifications are possible without departing from the scope of the invention.

### EXPERIMENT 1

### Preparation of Positive Electrode Active Material Al

(1) Preparation of Lithium-Transition Metal Composite Oxide

Li₂CO₃ and CoCO₃ were mixed in a mortar so that the mole ratio of Li and Co became 1:1. Thereafter, the mixture was sintered in an air atmosphere at 800° C. for 24 hours and then pulverized to obtain a powder of a lithium-cobalt composite oxide represented as LiCoO₂ and having an average particle size of 11 μm.

(2) Coating with Al₂O₃

A NH₃ aqueous solution was dropped into 5 L of 0.1 M (mole/liter) Al(NO₃)₃ aqueous solution, and the resultant solution was agitated for 10 minutes, followed by centrifugal separation to remove the supernatant liquor. Thus, Al(OH)₃ was obtained. This was added to 5 L of water and agitated for 10 minutes, to prepare a dispersion in which Al(OH)₃ particles were dispersed. Then, 5,400 g of LiCoO₂ was added to the dispersion, agitated for 10 minutes, and again subjected to centrifugal separation to remove the supernatant liquor. Thereafter, the resultant material was sintered in the air at 400° C. for 5 hours, to obtain a material in which Al₂O₃ particles were firmly adhered to the surface of LiCoO₂, serving as the positive electrode active material. The amount of the Al₂O₃ firmly adhered to the surface was 0.94 weight % with respect to the amount of LiCoO₂.

In order to identify the Al₂O₃ particles obtained by the above-described process, Al₂O₃ particles were prepared without adding LiCoO₂ in the above-described process, and the resultant Al₂O₃ particles were subjected to an XRD analysis. As a result, the profile for γ-Al₂O₃ was found. Thus, it was confirmed that γ-Al₂O₃ was produced by the above-described process.

Preparation of Positive Electrode Active Materials A2 to A5 Positive electrode active materials A2 to A5 were prepared in the same manner as described above, except that the concentrations of the Al(NO₃)₃ aqueous solution were set at 0.12M, 0.07M, 0.04M, and 0.02M, respectively, when coating the LiCoO₂ with Al₂O₃. In the resultant positive electrode active materials A2 to A5, the amounts of the firmly adhered Al₂O₃ were 1.13 weight %, 0.66 weight %, 0.38 weight %, and 0.19 weight %, respectively, with respect to the amount of LiCoO₂.

### Preparation of Positive Electrode Active Material A6

A positive electrode active material A6 in which Al₂O₃ and were firmly adhered to the surface of LiCoO₂ was prepared in the following manner.

A NH₃ aqueous solution was added to 1 L of 0.25M(NH₄)₂HPO₄ aqueous solution so that the pH became 10 or higher. Then, 6,800 g of LiCoO₂ prepared in the above-described manner was added to the resultant aqueous solution, and thereafter, 1 L of 0.25M Al(NO₃)₃ aqueous solution was gradually dropped into the resultant solution. This was agitated for 10 minutes and subjected to centrifugal separation to remove the supernatant liquor. Thereafter, 5 L of 0.15M LiOH aqueous solution was added thereto and agitated, and the resultant was again subjected to centrifugal separation to remove the supernatant liquor. Thereafter, the resultant material was sintered in the air at 400° C. for 5 hours, to obtain a material in which particles of Al₂O₃ and Li₃PO₄ were firmly adhered to the surface of LiCoO₂, serving as the positive electrode active material. The amounts of the Al₂O₃ and Li₃PO₄ firmly adhered to the surface were 0.38 weight % and 0.43 weight %, respectively, with respect to the amount of LiCoO₂.

In order to confirm the particles of Al₂O₃ and Li₃PO₄ firmly adhered to the LiCoO₂ in the above-described process, Al₂O₃ and Li₃PO₄ were deposited without adding LiCoO₂ in the above-described process, and they were sintered in the same manner as described above. The resultant materials were subjected to an XRD (X-ray diffraction) analysis.

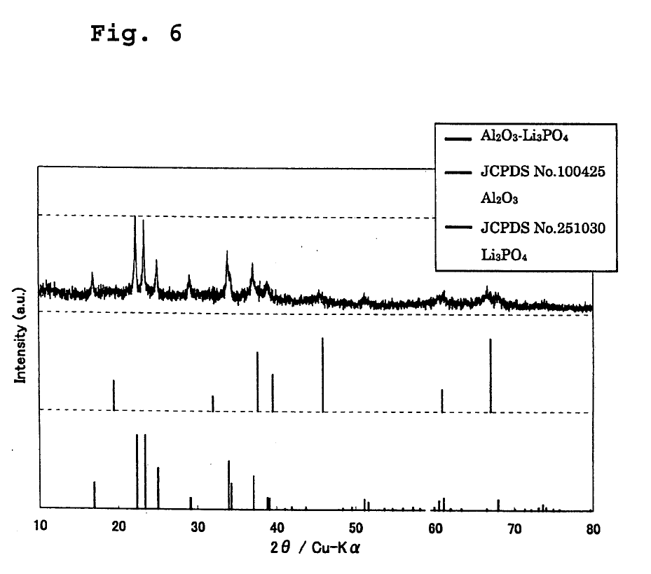

FIG. 6 is a chart illustrating the result of an XRD analysis for the resultant powder. As shown in FIG. 6, the peaks originating from Al₂O₃ and Li₃PO₄ were observed, so it was confirmed that Al₂O₃ and Li₃PO₄ were produced.

### Measurement of BET Specific Surface Area of the Positive Electrode Active Materials

The BET specific surface area was determined for each of the positive electrode active materials A1 through A6 and the positive electrode active material X1 (LiCoO₂), which was used as the base material. The results are shown in Table 1. Table 1 also shows the ratio of increase of the BET specific surface area (BET specific surface area after the firm adherence of the Al₂O₃ particles/BET specific surface area before the firm adherence of the Al₂O₃ particles) of each of the positive electrode active materials, as compared to that of the positive electrode active material before the firm adherence of the Al₂O₃ particles (i.e., the positive electrode active material X1).

TABLE 1

| | | | Increase of |
|---|---|---|---|
| | | | specific |
| | | BET specific surface | surface area |
| | Treatment | area | (times) |
| A2 | 1.13 wt. % Al₂O₃ | 2.24 m²/g | 8.0 |
| | coating | | |
| A1 | 0.94 wt. % Al₂O₃ | 2.03 m²/g | 7.3 |
| | coating | | |
| A3 | 0.66 wt. % Al₂O₃ | 1.67 m²/g | 6.0 |
| | coating | | |
| A4 | 0.38 wt. % Al₂O₃ | 0.75 m²/g | 2.7 |
| | coating | | |
| A5 | 0.19 wt. % Al₂O₃ | 0.43 m²/g | 1.5 |
| | coating | | |
| A6 | 0.19 wt. % Al₂O₃ + | 1.91 m²/g | 6.8 |
| | 0.43 wt. % Li₃PO₄ | | |
| | coating | | |
| X1 | No coating | 0.28 m²/g | — |

As clearly seen from Table 1, it was confirmed that in each of the positive electrode active materials A1 through A6, the BET specific surface area after the firm adherence of Al₂O₃ particles was 1.5 times to 8 times greater than that before the firm adherence of Al₂O₃ particles.

### EXPERIMENT 2

Prismatic lithium secondary batteries were fabricated using the foregoing positive electrode active materials A1 through A6 and X1 in the following manner.

### Preparation of Positive Electrode

A powder of each of the above-described positive electrode active materials, graphite powder having an average particle size of 2 μm as the positive electrode conductive agent, and polyvinylidene fluoride as the positive electrode binder were mixed so that the weight ratio of the active material, the conductive agent, and the binder became 95:2.5:2.5, and the mixture was kneaded to prepare a positive electrode mixture slurry.

The resultant positive electrode mixture slurry was applied onto both sides of a positive electrode current collector made of an aluminum foil with a thickness of 15 μm, a length of 402 mm, and a width of 50 mm so that the coating area on the obverse side had a length of 340 mm and a width of 50 mm and the coating area on the reverse side had a length of 270 mm and a width of 50 mm. Thereafter, the current collector coated with the slurry was dried and pressure-rolled. The amount of the active material layer on the current collector and the thickness of the positive electrode were 45 mg/cm² and 143 μm, measured at the portion where the active material layer was formed on both sides.

Then, an aluminum plate serving as a positive electrode current collector tab was connected to an end portion of the positive electrode on which the positive electrode mixture layer was not coated.

### Preparation of Negative Electrode

(1) Preparation of Silicon Negative Electrode Active Material

First, a polycrystalline silicon ingot was prepared by thermal reduction. Specifically, silicon seeds placed in a metal reactor (reducing furnace) were heated to 800° C., and a mixed gas of purified hydrogen and a gas vapor of high-purity monosilane (SiH₄) was flowed therein. Thus, polycrystalline silicon was deposited on the surfaces of the silicon seeds. Thereby, a polycrystalline silicon ingot was formed into a thick rod shape.

Next, the polycrystalline silicon ingot was pulverized and classified, so that polycrystalline silicon particles (negative electrode active material) having a purity of 99% were prepared. The polycrystalline silicon particles had a crystallite size of 32 nm and an average particle size of 10 μm.

The crystallite size was calculated from the half-width of silicon (111) peak determined by a powder X-ray diffraction analysis, using Scherrer's formula. The average particle size was determined by laser diffraction analysis.

(2) Preparation of Negative Electrode Mixture Slurry

The above-described negative electrode active material, graphite powder having an average particle size of 3.5 μm as the negative electrode conductive agents and a negative electrode binder were mixed together with NMP (N-methyl-2-pyrrolidone) as a dispersion medium so that the mass ratio of the negative electrode active material powder, the negative electrode conductive agent powder, and the polyimide resin after imidization became 100:3:8.6. The negative electrode binder was composed of a thermoplastic polyimide resin precursor varnish (solvent: NMP, concentration: 47 mass %, determined as the amount of the polyimide resin after polymerization and imidization by a heat treatment) having a molecular structure represented by the following chemical formula (1), a glass transition temperature of 300° C., and a weight-average molecular weight of 50,000. Thus, a negative electrode mixture slurry was prepared. Here, the varnish, which is the precursor of the polyimide resin, may be made from diethyl ester of 3,3′,4,4′-benzophenone tetracarboxylic acid represented by the following-chemical formula (2) and m-phenylenediamine represented by the following chemical formula (3). The just-mentioned diethyl ester of 3,3′,4,4′-benzophenone tetracarboxylic acid may be prepared by reacting 3,3′,4,4′-benzophenone tetracarboxylic dianhydride represented by the following chemical formula (4) with equivalent weight of ethanol in the presence of NMP.

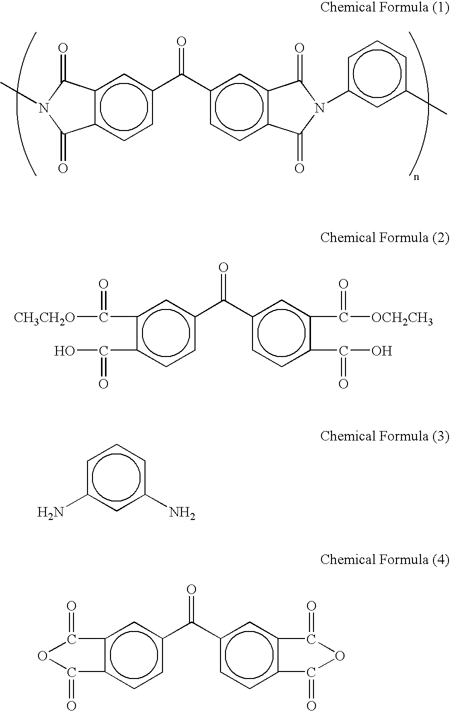

(3) Preparation of Negative Electrode

The just-described negative electrode mixture slurry was applied onto both sides of a negative electrode current collector made of a 18 μm-thick copper alloy foil (C7025 alloy foil, containing 96.2 weight % of Cu, 3 weight % of Ni, 0.65 weight % of Si, and 0.15 weight % of Mg) in the air at 25° C. The copper alloy foil had been roughed by electrolytic copper so as to have a surface roughness Ra (defined by Japanese Industrial Standard (JIS) B 0601-1994) of 0.25 μm and a mean spacing of local peaks S (also defined by JIS B 0601-1994) of 0.85 μm. The current collector coated with the slurry was dried in the air at 120° C. and then pressure-rolled in the air at 25° C. The resultant article was cut out into a rectangular shape with a length of 380 mm and a width of 52 mm, and thereafter subjected to a heat treatment at 400° C. for 10 hours under an argon atmosphere, to thus prepare a negative electrode in which a negative electrode active material layer was formed on the surfaces of the negative electrode current collector. The amount of the negative electrode mixture layer on the negative electrode current collector was 5.6 mg/cm², and the thickness of the negative electrode was 56 μm.

Then, a nickel plate serving as a negative electrode current collector tab was connected to an end portion of the negative electrode.

### Preparation of Non-aqueous Electrolyte Solution

Lithium hexafluorophosphate (LiPF₆) was dissolved at a concentration of 1.0 mole/L in a mixed solvent of 3:7 volume ratio of ethylene carbonate (EC) and diethyl carbonate (DEC), and thereafter, 0.4 weight % of carbon dioxide gas and 10 weight % of fluoroethylene carbonate were added thereto, to thus prepare a non-aqueous electrolyte solution.

### Preparation of Electrode Assembly

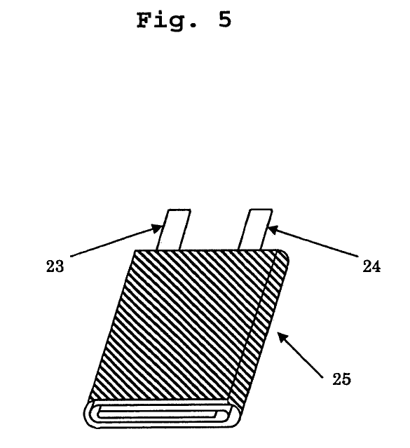

A sheet of the above-described positive electrode, a sheet of the above-described negative electrode, and two sheets of separators each having a thickness of 20 μm, a length of 450 mm, and a width of 54.5 mm were prepared. Each separator was made of a microporous polyethylene film having a penetration resistance of 340 g and a porosity of 39%. The positive electrode and the negative electrode were disposed facing each other with the separator interposed between them, and the positive and negative electrodes with the separators were spirally wound using a winding core having a diameter of 18 mm so that the positive electrode tab and the negative electrode tab were located at the outermost roll. Subsequently, the winding core was drawn out to prepare a spirally-wound electrode assembly. Thereafter, the electrode assembly was compressed to obtain a prismatic electrode assembly. FIG. 5 shows a schematic view illustrating the structure of the prepared spirally-wound electrode assembly.

As illustrated in FIG. 5, the positive electrode current collector tab 23 and the negative electrode current collector tab 24 are attached to the prismatic spirally-wound electrode assembly 25.

### Preparation of Lithium Secondary Battery

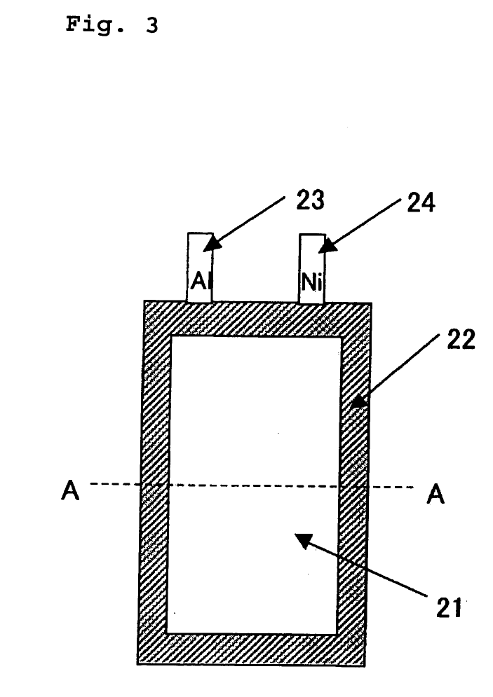

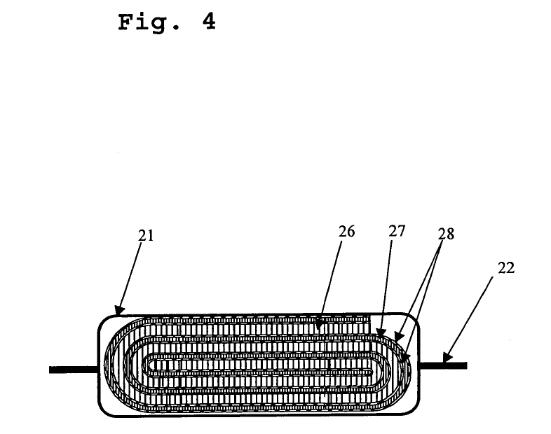

The above-described prismatic electrode assembly and the above-described electrolyte solution prepared in the above-described manner were put into an aluminum laminate battery case in a CO₂ atmosphere at 25° C. and 1 atm, to prepare a prismatic battery having the structure as shown in FIG. 3 (plan view). FIG. 4 is a cross-sectional view taken along line A-A in FIG. 3. As illustrated in FIGS. 3 and 4, the above-described prismatic spirally-wound electrode assembly 25 was inserted in the battery case 21 formed of an aluminum laminate, and a sealing part 22 at the periphery of the battery case 21 was heat sealed with the positive electrode current collector tab 23 and the negative electrode current collector tab 24 sticking outside, whereby a lithium secondary battery was prepared. In FIG. 4, 26 is the positive electrode, 27 is the negative electrode and 28 is the separator.

The batteries were fabricated in the above-described manner. The batteries employing the positive electrode active materials A1 through A6 according to the present invention are referred to as Batteries A1 through A6 of the invention, and a battery employing the comparative positive electrode active material X1 is referred to as Comparative Battery X1.

In addition, Comparative Battery X2 was fabricated using a positive electrode active material in which Al₂O₃ powder was admixed to the comparative positive electrode active material X1 in an amount of 0.94 weight %. The Al₂O₃ powder was prepared by depositing Al(OH)₃ in the same manner as described in the foregoing “Coating with Al₂O₃” but without adding LiCoO₂. The resultant article was separated, sintered, and pulverized in the same manner as in the foregoing, to prepare the Al₂O₃ powder.

### Evaluation of Charge-discharge Cycle Performance

The charge-discharge cycle performance for each of Batteries A1 to A5 of the invention and Comparative Batteries X1 and X2 was evaluated under the following charge-discharge cycle conditions. The cycle life is defined as the number of cycles at which the capacity retention ratio (a value obtained by dividing the discharge capacity at the n-th cycle by the discharge capacity at the first cycle) of the battery has reached 50%. The cycle life is represented by an index number relative to that of A1, where the cycle life of A1 is expressed as 100.

### Charge-Discharge Cycle Conditions

Charge Conditions for the First Cycle

Each of the batteries was charged at a constant current of 45 mA for 4 hours, thereafter charged at a constant current of 180 mA until the battery voltage reached 4.2 V, and further charged at a constant voltage of 4.2 V until the current value reached 45 mA.

Discharge Conditions for the First Cycle

Each of the batteries was discharged at a constant current of 180 mA until the battery voltage reached 2.75 V.

Charge Conditions for the Second Cycle Onward

Each of the batteries was charged at a constant current of 900 mA until the battery voltage reached 4.2 V and thereafter charged at a constant voltage of 4.2 V until the current value reached 45 mA.

Discharge Conditions for the Second Cycle Onward

Each of the batteries was discharged at a constant current of mA until the battery voltage reached 2.75 V.

Evaluation of Battery Thickness after the Initial Charge/Discharge

The battery thickness of each of Batteries A1 through A6 of the invention and Comparative Batteries X1 and X2 was measured after one charge-discharge cycle under the above-described charge-discharge conditions. The thickness was defined by the distance between two flat plates sandwiching the flat portion of the battery shown in FIG. 4. The battery thickness after the initial charge and discharge is represented by an index number relative to that of Battery A1 of the invention, which is taken as 100.

The cycle life and the battery thickness after the initial charge and discharge for each of Batteries A1 through A6 of the invention and Comparative Batteries X1 and X2 are shown in Table 2 below.

### Calculation of Porosity of Positive Electrode Active Material Layer

The porosity of each positive electrode active material layer was calculated from the following equation. It should be noted that the true density of the LiCoO₂ was set at 4.9 g/cm³, the true density of the graphite powder was 2.25 g/cm³, the true density of the polyvinylidene fluoride was 1.77 g/cm³ and the true density of the Al₂O₃ was 3.98 g/cm³ in the calculation.

Porosity=(Positive electrode thickness (μm)−Positive electrode current collector thickness (μm))−((Amount of positive electrode active material (mg)/True density of positive electrode active material (g/cm³)+Amount of binder (mg)/True density of binder (g/cm³)+Amount of conductive agent/True density of conductive agent (g/cm³)+Al₂O₃ (mg)/Al₂O₃ (g/cm³)) 10)/(Positive electrode thickness (μm)−Positive electrode current collector thickness (μm)) 100 Eq. (1)

Porosity={(143 (μm)−15 (μm))−(42.35/4.9+1.12/1.77+1.12/2.25+0.40/3.98) 10}/(143 (μm)−15 (μm)) 100=22.8(%)

As described above, the porosity of the positive electrode active material layer for Battery A1 of the invention was 22.8%. The porosity of the positive electrode active material layer for each of Batteries A2 to A6 of the invention and Comparative Batteries X1 and X2 was determined in the same manner as described above. The results are also shown in Table 2 below.

TABLE 2
Battery shape: Prismatic

| | Positive electrode active | | | | | |
|---|---|---|---|---|---|---|
| | material | | | Positive | Battery | |
| | | Increase of | | electrode | thickness | |
| | | specific | | active | after initial | |
| | | surface | Positive | material | charge | |
| | | area | electrode | layer | and | Cycle |
| Battery | Treatment | (times) | thickness | porosity | discharge | life |
| A2 | 1.13 wt. % | 8.0 | 143 μm | 22.8% | 100 | 96 |
| | Al₂O₃ coating | | | | | |
| A1 | 0.94 wt. % | 7.3 | 143 μm | 22.8% | 100 | 100 |
| | Al₂O₃ coating | | | | | |
| A3 | 0.66 wt. % | 6.0 | 143 μm | 22.9% | 100 | 106 |
| | Al₂O₃ coating | | | | | |
| A4 | 0.38 wt. % | 2.7 | 143 μm | 22.9% | 100 | 104 |
| | Al₂O₃ coating | | | | | |
| A5 | 0.19 wt. % | 1.5 | 143 μm | 22.9% | 100 | 92 |
| | Al₂O₃ coating | | | | | |
| A6 | 0.38 wt. % | 6.8 | 143 μm | 22.6% | 100 | 107 |
| | Al₂O₃ + 0.43 wt. | | | | | |
| | % Li₃PO₄ coating | | | | | |
| X1 | No coating | — | 143 μm | 23.0% | 100 | 83 |
| X2 | 0.94 wt. % Al₂O₃ | — | 143 μm | 22.8% | 100 | 77 |
| | powder addition | | | | | |

The results shown in Table 2 clearly demonstrate that Batteries A1 through A6 of the invention, employing the positive electrode active materials according to the present invention, exhibited longer cycle life than Comparative Batteries X1 and X2, and they achieved superior charge-discharge cycle performance. Moreover, particularly good charge-discharge cycle performance was obtained when the increase of the specific surface area was in the range of from 2.5 times to 7.5 times.

Battery A6 of the invention, employing a positive electrode active material coated with Li₃PO₄ as well as Al₂O₃, showed a longer cycle life than Batteries A1 and A4 of the invention, each employing a positive electrode active material coated with Al₂O₃ particles alone, and it achieved better charge-discharge cycle performance. The reason is believed to be that the presence of the Li₃PO₄ particles on the LiCoO₂ surface hindered the LiCoO₂ from deteriorating.

### EXPERIMENT 3

### Preparation of Batteries A1-1 to A1-6 of the Invention

Using the positive electrode active material A1, Batteries A1-1 to A1-6 of the invention were fabricated in the same manner as Battery A1 of the invention, except that the positive electrode thicknesses were varied as shown in Table 3 by varying only the conditions of pressure-rolling when preparing the positive electrodes.

### Preparation of Comparative Batteries X1-1 to X1-6

Using the comparative positive electrode active material X1, Comparative Batteries X1-1 to X1-6 were fabricated in the same manner as Comparative Battery X1, except that the positive electrode thicknesses were varied as shown in Table 3 by varying the conditions of pressure-rolling.

Evaluation of Charge-Discharge Cycle Performance and Battery Thickness after Initial Charge and Discharge

The charge-discharge cycle performance for each of Batteries A1-1 through A1-6 and Comparative Batteries X1-1 through X1-6 was evaluated in the same manner as described above. The results are shown in Table 3 below. The battery thickness after initial charge and discharge for each battery was also measured in the same manner as described above. The results are also shown in Table 3. Furthermore, Table 3 also shows the porosity of the positive electrode active material layer for each battery, calculated in the same manner as described above. Note that Table 3 also shows the results for Battery A1 of the invention.

TABLE 3
Battery shape: Prismatic

| | | | Porosity | Battery | |
|---|---|---|---|---|---|
| | | | of | thickness | |
| | | | positive | after | |
| | Positive | | electrode | initial | |
| | electrode | Positive | active | charge | |
| | active | electrode | material | and | Cycle |
| Battery | material | thickness | layer | discharge | life |
| A1-1 | 0.94 wt. % | 155 μm | 29.4% | 106 | 89 |
| | Al₂O₃ Coating | | | | |
| A1-2 | 0.94 wt. % | 151 μm | 27.5% | 103 | 102 |
| | Al₂O₃ Coating | | | | |
| A1-3 | 0.94 wt. % | 147 μm | 25.2% | 101 | 107 |
| | Al₂O₃ Coating | | | | |
| A1 | 0.94 wt. % | 143 μm | 22.8% | 100 | 100 |
| | Al₂O₃ Coating | | | | |
| A1-4 | 0.94 wt. % | 139 μm | 20.3% | 99 | 99 |
| | Al₂O₃ Coating | | | | |
| A1-5 | 0.94 wt. % | 135 μm | 17.7% | 98 | 94 |
| | Al₂O₃ Coating | | | | |
| A1-6 | 0.94 wt. % | 131 μm | 14.8% | 96 | 79 |
| | Al₂O₃ Coating | | | | |
| X1-1 | No coating | 155 μm | 29.6% | 107 | 85 |
| X1-2 | No coating | 151 μm | 27.5% | 103 | 88 |
| X1-3 | No coating | 147 μm | 25.3% | 101 | 86 |
| X1 | No coating | 143 μm | 23.0% | 100 | 83 |
| X1-4 | No coating | 139 μm | 20.5% | 98 | 73 |
| X1-5 | No coating | 135 μm | 17.8% | 97 | 67 |
| X1-6 | No coating | 131 μm | 15.0% | 95 | 45 |

As seen from Table 3, it will be appreciated that the cycle life, i.e., the charge-discharge cycle performance is affected by the positive electrode thickness and the porosity of the positive electrode active material layer. When the positive electrode thickness and the porosity of the positive electrode active material layer are less, a higher battery energy density can be obtained. However, when the positive electrode thickness and the porosity of the positive electrode active material layer become too small, the charge-discharge cycle performance deteriorates, as shown in Table 3. It is understood that the porosity of the positive electrode active material layer should preferably be within the range of from 15% to 28%, in order to obtain a high energy density and also achieve good charge-discharge cycle performance.

It should be noted that although the cycle life of Battery A1-6 of the invention is shorter than those of Comparative Batteries X1-1 to X1, it is longer than that of Comparative Battery X1-6, which has the same positive electrode thickness, so it is understood that Battery A1-6 of the invention has superior charge-discharge cycle performance.

### EXPERIMENT 4

Using the foregoing positive electrode active materials A1 through A6 and X1 and X2, cylindrical lithium secondary batteries were fabricated in the following manner.

### Preparation of Positive Electrode

A positive electrode was prepared in the same manner as the positive electrode in Experiment 2 above, except for the following. An aluminum foil having a thickness of 15 μm, a length of 480 mm, and a width of 33.7 mm was used as the positive electrode current collector, and the positive electrode active material slurry was applied onto both sides of the aluminum foil so that the coating area of both the obverse and reverse sides had a length of 450 mm and a width of 33.7 mm. Thereafter, the resultant material was dried and pressure-rolled to prepare the positive electrode.

### Preparation of Negative Electrode

A negative electrode was prepared in the same manner as the negative electrode in Experiment 2 above, except that the dimensions of the negative electrode were 495 mm long and 35.7 mm wide.

### Preparation of Electrode Assembly

A sheet of the above-described positive electrode, a sheet of the above-described negative electrode, and two sheets of the separators each made of the same microporous polyethylene film as in Battery A1 of the invention were prepared. The positive electrode and the negative electrode were disposed facing each other with the separators interposed between them, and the positive and negative electrodes with the separators were spirally wound using a winding core having a diameter of 4 mm so that the positive electrode tab was located at the innermost roll and the negative electrode tab was located at the outermost roll. The dimensions of the separator used were 545 mm long and 37.7 mm wide. After winding the electrodes with the separators, the winding core was drawn out, and thus, a spirally-wound electrode assembly with a diameter of 12.8 mm and a height of 37.7 mm was prepared.

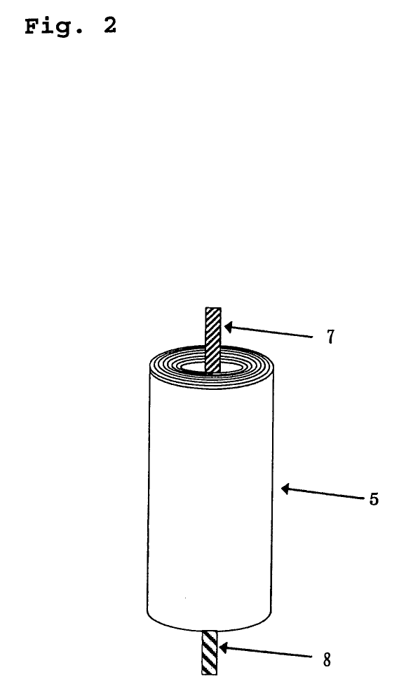

FIG. 2 is a perspective view illustrating the cylindrical electrode assembly prepared in the above-described manner. As illustrated in FIG. 2, the positive electrode current collector tab 7 extends upward from the electrode assembly 5, while the negative electrode current collector tab 8 extends downward therefrom.

### Preparation of Lithium Secondary Battery

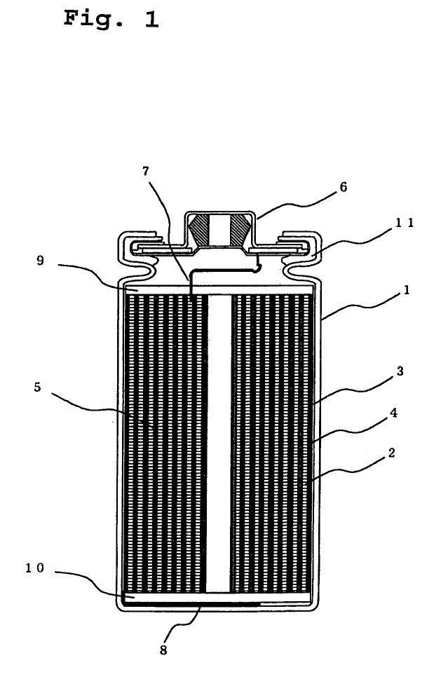

The above-described cylindrical electrode assembly and the above-described electrolyte solution were put into a cylindrical battery case made of SUS, in a CO₂ atmosphere at 25° C. and 1 atm, to prepare a cylindrical battery B1 of the present invention that had the cross-sectional structure as shown in FIG. 1 and had a diameter of 14 mm and a height of 43 mm.

The cylindrical lithium secondary battery comprises, as illustrated in FIG. 1, a cylindrical metal battery can 1 having an opening at its top end, an electrode assembly 5 in which the positive electrode 2 and the negative electrode 3 are spirally wound so as to face each other with the separator 4 interposed therebetween, the non-aqueous electrolyte solution impregnated in the electrode assembly, and a sealing lid 6 for sealing the opening of the metal battery can 1.

The sealing lid 6 serves as the positive electrode terminal, while the metal battery can 1 serves as the negative electrode terminal. The positive electrode current collector tab 7 attached to the upper side of the electrode assembly 5 is connected to the sealing lid 6, and the negative electrode current collector tab 8 attached to the lower side of the electrode assembly 5 is connected to the metal battery can 1. The upper and lower faces of the electrode assembly 5 is covered with an upper insulating plate 9 and a lower insulating plate 10, respectively, for insulating the electrode assembly 5 from the metal battery can 1. The sealing lid is fixed to the opening of the metal battery can 1 by crimping it with an insulative packing 11 interposed therebetween.

As described above, the cylindrical battery B1 of the invention has a structure that enables charging and discharging as a secondary battery.

The non-aqueous electrolyte solution was the same one as used for Battery A1 of the invention.

Using the foregoing positive electrode active materials A2 through A6 and comparative active materials X1 and X2, cylindrical lithium secondary batteries were fabricated in the same manner as described above. The batteries prepared using the positive electrode active materials A2 to A6 are referred to as Batteries B2 to B6 of the invention, respectively. Likewise, the batteries prepared using the comparative positive electrode active materials X1 and X2 are referred to as Comparative Batteries Y1 and Y2, respectively.

### Evaluation of Charge-Discharge Cycle Performance

The charge-discharge cycle performance for each of Batteries B1 through B6 and Comparative Batteries Y1 and Y2 was evaluated in the same manner as described above. The results are shown in Table 4 below. Furthermore, Table 4 also shows the porosity of the positive electrode active material layer for each battery, calculated in the same manner as described above.

TABLE 4
Battery shape: cylindrical

| | Positive electrode | | | | | | | |
|---|---|---|---|---|---|---|---|---|
| | active material | | | | Battery component length | | | |
| | | Increase | | | Positive | | | |
| | | of | | Positive | electrode | | | |
| | | specific | | electrode | (Coated | | | |
| | | surface | Positive | active | area + | | | |
| | | area | electrode | material | uncoated | Negative | | Cycle |
| Battery | Treatment | (times) | thickness | porosity | area) | electrode | Separator | life |
| B2 | 1.13 wt. % | 8.0 | 143 μm | 22.8% | 450 + 30 mm | 495 mm | 545 mm | 89 |
| | Al₂O₃ coating | | | | | | | |
| B1 | 0.94 wt. % | 7.3 | 143 μm | 22.8% | 450 + 30 mm | 495 mm | 545 mm | 94 |
| | Al₂O₃ coating | | | | | | | |
| B3 | 0.66 wt. % | 6.0 | 143 μm | 22.9% | 450 + 30 mm | 495 mm | 545 mm | 97 |
| | Al₂O₃ coating | | | | | | | |
| B4 | 0.38 wt. % | 2.7 | 143 μm | 22.9% | 450 + 30 mm | 495 mm | 545 mm | 96 |
| | Al₂O₃ coating | | | | | | | |
| B5 | 0.19 wt. % | 1.5 | 143 μm | 22.9% | 450 + 30 mm | 495 mm | 545 mm | 82 |
| | Al₂O₃ coating | | | | | | | |
| B6 | 0.38 wt. % | 6.8 | 143 μm | 22.6% | 450 + 30 mm | 495 mm | 545 mm | 101 |
| | Al₂O₃coating + | | | | | | | |
| | 0.43 wt. % | | | | | | | |
| | Li₃PO₄coating | | | | | | | |
| Y1 | No coating | — | 143 μm | 23.0% | 450 + 30 mm | 495 mm | 545 mm | 33 |
| Y2 | 0.94 wt. % | — | 143 μm | 22.8% | 450 + 30 mm | 495 mm | 545 mm | 22 |
| | Al₂O₃ powder | | | | | | | |
| | added | | | | | | | |

As clearly seen from the results shown in Table 4, Batteries B1 to B5 of the invention, employing the positive electrode active materials according to the present invention, showed longer cycle life than Comparative Batteries Y1 and Y2, and they achieved superior charge-discharge cycle performance. As shown in Table 4, the cylindrical batteries showed greater differences in charge-discharge cycle performance between the batteries according to the invention and the comparative batteries than in the cases of prismatic batteries shown in Table 2. Thus, it will be appreciated that the advantageous effects of the present invention are more significant in cylindrical batteries. The reason is believed to be as follows. In a cylindrical battery, deformation of the wound assembly is less likely to occur than in a prismatic battery, and deterioration of the electrolyte retention capability in the positive electrode is more likely to occur because the positive electrode active material layer is compressed during charge, i.e., when the silicon negative electrode active material expands. Therefore, it is believed that when Al₂O₃ particles are firmly adhered to the positive electrode active material according to the present invention, the effect of improving the electrolyte retention capability of the positive electrode is exhibited more significantly.

### EXPERIMENT 5

### Preparation of Batteries B1-1 to B1-4 of the Invention

Using the positive electrode active material A1, Batteries B1-1 to B1-4 of the invention were fabricated in the same manner as Battery B1 of the invention, except that the positive electrode thicknesses were varied as shown in Table 5 by varying only the conditions of pressure-rolling when preparing the positive electrodes. It should be noted that the lengths of the positive electrode, the negative electrode, and the separator were varied as shown in Table 5 according to the variations of the positive electrode thicknesses so that the diameter of the cylindrical electrode assembly became the same diameter 12.8 mm as that of Batteries B1 to B6 of the invention and Comparative Batteries Y1 and Y2.

### Preparation of Comparative Batteries Y1-1 to Y1-4

Using the comparative positive electrode active material X1, Comparative Batteries Y1-1 to Y1-4 were fabricated in the same manner as Comparative Battery Y1, except that the positive electrode thicknesses were varied as shown in Table 5 by varying the conditions of pressure-rolling. It should be noted that the lengths of the positive electrode, the negative electrode, and the separator were varied as shown in Table 5 according to the variations of the positive electrode thicknesses so that the diameter of the cylindrical electrode assembly became the same diameter 12.8 mm as that of Batteries B1 to B6 of the invention and Comparative Batteries Y1 and Y2.

### Evaluation of Charge-Discharge Cycle Performance

The charge-discharge cycle performance for each of Batteries through B1-4 and Comparative Batteries Y1-1 through Y1-4 was evaluated in the same manner as described above. The results are shown in Table 5 below. Furthermore, Table 5 also shows the porosity of the positive electrode active material layer for each battery, calculated in the same manner as described above.

TABLE 5
Battery shape: cylindrical

| | | | | Battery component length | | | |
|---|---|---|---|---|---|---|---|
| | | | | Positive | | | |
| | | | Positive | electrode | | | |
| | | | electrode | (Coated | | | |
| | Positive | Positive | active | area + | | | |
| | electrode | electrode | material | uncoated | Negative | | |
| Battery | active material | thickness | porosity | area) | electrode | Separator | Cycle life |
| B1-1 | 0.94 wt. % Al₂O₃ | 155 μm | 29.4% | 428 + 30 mm | 473 mm | 523 mm | 83 |
| | coating | | | | | | |
| B1-2 | 0.94 wt. % Al₂O₃ | 151 μm | 27.5% | 435 + 30 mm | 480 mm | 530 mm | 96 |
| | coating | | | | | | |
| B1 | 0.94 wt. % Al₂O₃ | 143 μm | 22.8% | 450 + 30 mm | 495 mm | 545 mm | 94 |
| | coating | | | | | | |
| B1-3 | 0.94 wt. % Al₂O₃ | 135 μm | 17.7% | 465 + 30 mm | 510 mm | 560 mm | 89 |
| | coating | | | | | | |
| B1-4 | 0.94 wt. % Al₂O₃ | 131 μm | 14.8% | 473 + 30 mm | 518 mm | 568 mm | 73 |
| | coating | | | | | | |
| Y1-1 | No coating | 155 μm | 29.6% | 428 + 30 mm | 473 mm | 523 mm | 56 |
| y1-2 | No coating | 151 μm | 27.5% | 435 + 30 mm | 480 mm | 530 mm | 54 |
| Y1 | No coating | 143 μm | 23.0% | 450 + 30 mm | 495 mm | 545 mm | 33 |
| Y1-3 | No coating | 135 μm | 17.8% | 465 + 30 mm | 510 mm | 560 mm | 39 |
| Y1-4 | No coating | 131 μm | 15.0% | 473 + 30 mm | 518 mm | 568 mm | 21 |

As seen from Table 5, the charge-discharge cycle performance was affected by the porosity of the positive electrode active material layer also in the cylindrical batteries, and when the porosity of the positive electrode active material layer was too small, the charge-discharge cycle performance deteriorated. However, when the porosity of the positive electrode active material layer is smaller, the energy density of the battery becomes higher. It will be understood that, in the case of cylindrical batteries as well, the porosity of the positive electrode active material layer should preferably be within the range of from 15 to 28%, from the viewpoint of increasing the energy density and improving the charge-discharge cycle performance.

It is understood also from the results shown in Table 5 that the advantageous effects of the present invention are exhibited more noticeably in the case of cylindrical batteries than in the case of prismatic batteries. The reason is believed to be that deterioration of the electrolyte retention capability in the positive electrode tends to occur more easily in cylindrical batteries than in prismatic batteries.

### REFERENCE EXPERIMENT

A study was conducted about the influence of adhesion of Al₂O₃ particles to the positive electrode active material particles when artificial graphite was used as the negative electrode.

### Preparation of Negative Electrode

Artificial graphite having an average particle size of 20 μm as the negative electrode active material and styrene-butadiene rubber as the binder agent were admixed into an aqueous solution in which carboxymethylcellulose as a thickening agent was dissolved in water as a dispersion medium, so that the weight ratio of the active material, the binder agent, and the thickening agent became 97.5:1:1.5, to thus prepare a negative electrode slurry. The resultant slurry was applied onto both sides of a negative electrode current collector made of an electrolytic copper foil with a thickness of 9 μm, a length of 380 mm, and a width of 52 mm so that the coating area on the obverse side had a length of 350 mm and a width of 52 mm and the coating area on the reverse side had a length of 290 mm and a width of 52 mm. Thereafter, the current collector coated with the slurry was dried and pressure-rolled. The amount of the active material layer on the current collector and the thickness of the negative electrode were 195 mg/cm² and 130 μm, measured at the portion where the active material layer was formed on both sides.

### Preparation of Non-Aqueous Electrolyte Solution

Lithium hexafluorophosphate (LiPF₆) was dissolved at a concentration of 1.0 mole/L in a mixed solvent of 3:7 volume ratio of ethylene carbonate (EC) and dimethyl carbonate (DMC), and thereafter, 2 weight % of vinylene carbonate (VC) was added to the resultant solution, to thus prepare a non-aqueous electrolyte solution.

### Preparation of Lithium Secondary Battery

Using the just-described positive electrode, the just-described non-aqueous electrolyte, and the positive electrode used in Battery A1 of the invention above, a prismatic lithium secondary battery was fabricated in the same manner as Battery A1 of the invention above. This battery is referred to as Reference Battery Z1.

A prismatic lithium secondary battery was prepared in the same manner as the just-described Reference Battery Z1, except that the positive electrode was the same one as used in Comparative Battery X1. This battery is referred to as Reference Battery Z2.

A prismatic lithium secondary battery was prepared in the same manner as the just-described Reference Battery Z1, except that the positive electrode was the same one as used for Battery A6 of the invention above. This battery is referred to as Reference Battery Z3.

Evaluation of Charge-Discharge Cycle Performance and Battery Thickness after Initial Charge and Discharge

The charge-discharge cycle performance for each of Reference Batteries Z1 to Z3 was evaluated in the same manner as described above. The results are shown in Table 6 below. The battery thickness after initial charge and discharge for each battery was also measured in the same manner as described above. The results are also shown in Table 6. Furthermore, Table 6 also shows the porosity of the positive electrode active material layer for each battery, calculated in the same manner as described above.

TABLE 6

| | Positive electrode active | | | Positive | Battery | |
|---|---|---|---|---|---|---|
| | material | | | electrode | thickness | |
| | | Increase of | Positive | active | after initial | |
| | | specific | electrode | material | charge and | |
| Battery | Treatment | surface area | thickness | porosity | discharge | Cycle life |
| Reference | 0.94 wt. % | 7.3 | 143 μm | 22.8% | 100 | 100 |
| Battery Z1 | Al₂O₃ coating | | | | | |
| Reference | No coating | — | 143 μm | 23.0% | 100 | 100 |
| Battery Z2 | | | | | | |
| Reference | 0.38 wt. % | 6.8 | 143 μm | 22.6% | 100 | 102 |
| Battery Z3 | Al₂O₃coating + | | | | | |
| | 0.43 wt. % | | | | | |
| | Li₃PO₄coating | | | | | |

As seen from Table 6, Reference Batteries Z1 and Z3, which used the positive electrode active materials according to the invention, showed charge-discharge cycle performance as low as that of Reference Battery Z2, which used the comparative positive electrode active material. This means that when a graphite material is used as the negative electrode active material, the advantageous effects of the present invention cannot be obtained. Accordingly, it will be understood that the advantageous effects of the present invention are unique to the case in which the particles of silicon and/or a silicon alloy are used as the negative electrode active material.

### EXPERIMENT 6

In the present experiment, a study was conducted about the influence of the use of dimethyl carbonate as a solvent for the non-aqueous electrolyte on the charge-discharge cycle performance.

### Preparation of Batteries B1-5 and B6-2 of the Invention as Well as Comparative Batteries Y1-5 and Y2-2

### Preparation of Non-Aqueous Electrolyte Solution

Lithium hexafluorophosphate (LiPF₆) was dissolved at a concentration of 1.0 mole/L in a mixed solvent of 2:8 volume ratio of fluoroethylene carbonate (FEC) and dimethyl carbonate (DMC).. Thereafter, 0.4 mass % of carbon dioxide gas was added to the resultant solution, to thus prepare a non-aqueous electrolyte solution.

Batteries B1-5 and B6-2 of the invention as well as Comparative Batteries Y1-5 and Y2-2 were fabricated in the same manners as Batteries B1 and B6 of the invention as well as Comparative Batteries Y1 and Y2, respectively, except that the just-described non-aqueous electrolyte solution was used as the non-aqueous electrolyte solution.

### Preparation of Batteries B1-6 and B6-3 of the Invention as Well as Comparative Batteries Y1-6 and Y2-3

### Preparation of Non-Aqueous Electrolyte Solution

Lithium hexafluorophosphate (LiPF₆) was dissolved at a concentration of 1.0 mole/L in a mixed solvent of 2:3:5 volume ratio of fluoroethylene carbonate (FEC), dimethyl carbonate (DMC), and methyl propionate (MP). Thereafter, 0.4 mass % of carbon dioxide gas was added to the resultant solution, to thus prepare a non-aqueous electrolyte solution.

Batteries B1-6 and B6-3 of the invention as well as Comparative Batteries Y1-6 and Y2-3 were fabricated in the same manners as Batteries B1 and B6 of the invention as well as Comparative Batteries Y1 and Y2, respectively, except that the just-described non-aqueous electrolyte solution was used as the non-aqueous electrolyte solution.

### Evaluation of Charge-Discharge Cycle Performance

The charge-discharge cycle performance was evaluated for each of the above-described batteries, in the same manner as described for the foregoing Battery A1 of the invention. The results of the measurement are shown in Table 7 below. It should be noted that the cycle life for each of the batteries is an index number relative to the cycle life of Battery Al of the invention, which is taken as 100.

TABLE 7

| | Positive electrode active | | | Positive | | |
|---|---|---|---|---|---|---|
| | material | | | electrode | | |
| | | Increase of | | active | | |
| | | specific | Positive | material | | |
| | | surface | electrode | layer | | |
| Battery | Treatment | area(times) | thickness | porosity | Electrolyte | Cycle life |
| B1-5 | 0.94 wt. % Al₂O₃ | 7.3 | 143 μm | 22.8% | 1M | 110 |
| | coating | | | | LiPF₆FEC/DMC | |
| | | | | | (2/8) + 0.4 wt. | |
| | | | | | % CO₂ | |
| B6-2 | 0.38 wt. % Al₂O₃ + | 6.8 | 143 μm | 22.6% | 1M | 112 |
| | 0.43 wt. % | | | | LiPF₆FEC/DMC | |
| | Li₃PO₄ coating | | | | (2/8) + 0.4 wt. | |
| | | | | | % CO₂ | |
| Y1-5 | No coating | — | 143 μm | 23.0% | 1M | 25 |
| | | | | | LiPF₆FEC/DMC | |
| | | | | | (2/8) + 0.4 wt. | |
| | | | | | % CO₂ | |
| Y2-2 | 0.94 wt. % Al₂O₃ | — | 143 μm | 22.8% | 1M | 27 |
| | powder added | | | | LiPF₆FEC/DMC | |
| | | | | | (2/8) + 0.4 wt. | |
| | | | | | % CO₂ | |
| B1-6 | 0.94 wt. % Al₂O₃ | 7.3 | 143 μm | 22.8% | 1M | 115 |
| | coating | | | | LiPF₆FEC/DMC/ | |
| | | | | | MP(2/3/5) + | |
| | | | | | 0.4 wt. % CO₂ | |
| B6-3 | 0.38 wt. % Al₂O₃ + | 6.8 | 143 μm | 22.6% | 1M | 113 |
| | 0.43 wt. % | | | | LiPF₆FEC/DMC/ | |
| | Li₃PO₄ coating | | | | MP(2/3/5) + | |
| | | | | | 0.4 wt. % CO₂ | |
| Y1-6 | No coating | — | 143 μm | 23.0% | 1M | 28 |
| | | | | | LiPF₆FEC/DMC/ | |
| | | | | | MP(2/3/5) + | |
| | | | | | 0.4 wt. % CO₂ | |
| Y2-3 | 0.94 wt. % Al₂O₃ | — | 143 μm | 22.8% | 1M | 26 |
| | powder added | | | | LiPF₆FEC/DMC/ | |
| | | | | | MP(2/3/5) + | |
| | | | | | 0.4 wt. % CO₂ | |
| B1 | 0.94 wt. % Al₂O₃ | 7.3 | 143 μm | 22.8% | 1M | 94 |
| | coating | | | | LiPF₆EC/DEC | |
| | | | | | (3/7) + 10 wt. | |
| | | | | | % FEC + | |
| | | | | | 0.4 wt. % CO₂ | |
| B6 | 0.38 wt. % Al₂O₃ + | 6.8 | 143 μm | 22.6% | 1M | 101 |
| | 0.43 wt. % | | | | LiPF₆EC/DEC | |
| | Li₃PO₄ coating | | | | (3/7) + 10 wt. | |
| | | | | | % FEC + | |
| | | | | | 0.4 wt. % CO₂ | |
| Y1 | No coating | — | 143 μm | 23.0% | 1M | 33 |
| | | | | | LiPF₆EC/DEC | |
| | | | | | (3/7) + 10 wt. | |
| | | | | | % FEC + | |
| | | | | | 0.4 wt. % CO₂ | |
| Y2 | 0.94 wt. % Al₂O₃ | — | 143 μm | 22.8% | 1M | 32 |
| | powder added | | | | LiPF₆EC/DEC | |
| | | | | | (3/7) + 10 wt. | |
| | | | | | % FEC + | |
| | | | | | 0.4 wt. % CO₂ | |

As clearly seen from the results shown in Table 7, the use of dimethyl carbonate as a solvent of the non-aqueous electrolyte solution resulted in improvements in the charge-discharge cycle performance for Batteries B1-5, B1-6, B6-2, and B6-3 of the invention. In contrast, the use of dimethyl carbonate resulted in rather lower charge-discharge cycle performance for Comparative Batteries Y1-5, Y1-6, Y2-2, and Y2-3.

The reason is believed to be as follows. In the batteries according to the invention, Al₂O₃ particles or Al₂O₃—Li₃PO₄ particles are firmly adhered to the surface of the positive electrode active material. Therefore, the proportion of the non-aqueous electrolyte solution that directly comes into contact with the positive electrode active material is significantly small. This makes it possible to hinder oxidative decomposition of the dimethyl carbonate on the positive electrode surface and further decomposition of the reductive decomposition product of the dimethyl carbonate. Therefore, the use of dimethyl carbonate, which has a low viscosity, results in the effect of improving the electrolyte permeability in the positive electrode. Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims the priority under 35 U.S.C. §119 of Japanese patent application Nos. 2007-252092 and 2008-083896 filed Sep. 27, 2007, and Mar. 27, 2008, respectively, each of which is incorporated by reference herein.

What is claimed is:

1. A lithium secondary battery comprising:
a battery case;
a non-aqueous electrolyte; and
an electrode assembly accommodated in the battery case, the electrode assembly comprising a positive electrode, a negative electrode, and a separator disposed between the positive electrode and the negative electrode, the positive electrode and the negative electrode being disposed facing each other across the separator and being wound; and
the negative electrode comprising a negative electrode current collector and a negative electrode active material layer disposed on the negative electrode current collector, the negative electrode active material layer comprising a negative electrode binder and a negative electrode active material containing particles of silicon and/or a silicon alloy; and
the positive electrode comprising a positive electrode current collector and a positive electrode active material layer disposed on the positive electrode current collector, the positive electrode active material layer comprising a positive electrode binder and a positive electrode active material containing a layered lithium-transition metal composite oxide, wherein Al₂O₃ particles are adhered to a surface of the lithium-transition metal composite oxide so that a BET specific surface area of the positive electrode active material after the adherence of the Al₂O₃ particles is from 1.5 times to 8 times greater than that before the adherence of the Al₂O₃ particles.

2. The lithium secondary battery according to claim 1, wherein the positive electrode active material layer has a porosity of from 15% to 28%.

3. The lithium secondary battery according to. claim 1, wherein the BET specific surface area of the positive electrode active material after the adherence of the Al₂O₃ particles is from 2.5 times to 7.5 times greater than that before the adherence of the Al₂O₃ particles.

4. The lithium secondary battery according to claim 2, wherein the BET specific surface area of the positive electrode active material after the adherence of the Al₂O₃ particles is from 2.5 times to 7.5 times greater than that before the adherence of the Al₂O₃ particles.

5. The lithium secondary battery according to claim 1, wherein Li₃PO₄ particles are adhered to the lithium-transition metal composite oxide in addition to the Al₂O₃ particles so that the BET specific surface area can be obtained.

6. The lithium secondary battery according to claim 2, wherein Li₃PO₄ particles are adhered to the lithium-transition metal composite oxide in addition to the Al₂O₃ particles so that the BET specific surface area can be obtained.

7. The lithium secondary battery according to claim 1, wherein the electrode assembly is in a spiral shape, and the battery case is in a cylindrical shape.

8. The lithium secondary battery according to claim 2, wherein the electrode assembly is in a spiral shape, and the battery case is in a cylindrical shape.

9. The lithium secondary battery according to claim 1, wherein the non-aqueous electrolyte contains dimethyl carbonate as a solvent.

10. The lithium secondary battery according to claim 2, wherein the non-aqueous electrolyte contains dimethyl carbonate as a solvent.

11. The lithium secondary battery according to claim 3, wherein the non-aqueous electrolyte contains dimethyl carbonate as a solvent.

12. The lithium secondary battery according to claim 4, wherein the non-aqueous electrolyte contains dimethyl carbonate as a solvent.

13. The lithium secondary battery according to claim 5, wherein the non-aqueous electrolyte contains dimethyl carbonate as a solvent.

14. The lithium secondary battery according to claim 6, wherein the non-aqueous electrolyte contains dimethyl carbonate as a solvent.

15. The lithium secondary battery according to claim 7, wherein the non-aqueous electrolyte contains dimethyl carbonate as a solvent.

16. The lithium secondary battery according to claim 8, wherein the non-aqueous electrolyte contains dimethyl carbonate as a solvent.

17. The lithium secondary battery according to claim 9, wherein the non-aqueous electrolyte contains dimethyl carbonate as a solvent.
